(19) United States
(12) Patent Application Publication
(10) Pub. No.: US 2026/0342903 A1
(43) Pub. Date: Oct. 29, 2026

(54) REMINDER METHOD BASED ON USER ACTION AND ELECTRONIC DEVICE THEREOF

(71) Applicant: SAMSUNG ELECTRONICS CO., LTD., Suwon-si (KR)

(72) Inventors: Kyeongjin JEON, Suwon-si (KR); Doosuk KANG, Suwon-si (KR); Hyeongseok KIM, Suwon-si (KR); Sungkweon PARK, Suwon-si (KR); Donghee SUH, Suwon-si (KR)

(21) Appl. No.: 19/711,690

(22) Filed: Jun. 17, 2026

Related U.S. Application Data
(63) Continuation of application No. PCT/KR2024/017036, filed on Nov. 1, 2024.

(30) Foreign Application Priority Data
Jan. 19, 2024 (KR) 10-2024-0008693
Apr. 26, 2024 (KR) 10-2024-0055977

(51) Int. Cl. H04M 1/72451; H04M 1/72436

(52) U.S. Cl. CPC H04M 1/72451; H04M 1/72436; H04M 2201/38

(57) ABSTRACT

An electronic device may include: a display; a memory storing instructions; and a processor, wherein the instructions stored in the memory, when executed by the processor, may cause the electronic device to: collect at least one of information stored in an application installed in the electronic device, information stored in the memory, an event received through the application, information stored in the memory, and/or setting information set in the electronic device; analyze the collected information to determine a usage pattern of a user, generate prompt information to be provided to generative artificial intelligence by analyzing the usage pattern of the user, generate AI notification information through the generative artificial intelligence based on the prompt information; and provide the AI notification information if an action predicted through the generative artificial intelligence is not performed.

### CROSS-REFERENCE TO RELATED APPLICATIONS

This application is a continuation of International Application No. PCT/KR2024/017036 designating the United States, filed on Nov. 1, 2024, in the Korean Ministry of Intellectual Property Receiving Office and claiming priority to Korean Patent Application Nos. 10-2024-0008693, filed on Jan. 19, 2024, and 10-2024-0055977, filed on Apr. 26, 2024, in the Korean Ministry of Intellectual Property, the disclosures of each of which are incorporated by reference herein in their entireties.

### BACKGROUND

### Field

The disclosure relates to a reminder method based on a user action and an electronic device thereof.

### Description of Related Art

With the development of digital technology, various types of electronic devices, such as mobile communication terminals, personal digital assistants (PDAs), electronic notebooks, smartphones, tablet personal computers (PCs), or wearable devices, are widely used. In order to support and enhance functions, hardware and/or software of the electronic device are continuously improved.

An electronic device may provide a reminder service, based on schedule information registered in a calendar application. For example, a user may register a schedule or alarm in the electronic device regarding matters that the user must not forget, wants to remember, or needs to reconfirm.

A user needs to directly register a reminder for a desired operation in an electronic device, which is inconvenient. The user may register the reminder in the electronic device through a voice command, but there is an inconvenience in that a voice command is required.

### SUMMARY

Embodiments of the disclosure may provide a method and a device for analyzing information stored in an application installed in an electronic device, information stored in an external device (e.g., an IoT device or a wearable device) connected to the electronic device, sensing information, information stored in an external server, and/or information stored in a memory of the electronic device, and displaying AI notification information at a time at which a reminder is needed, based on the analyzed result.

An electronic device according to an example embodiment of the disclosure may include: a display, a memory storing instructions, and at least one processor, comprising processing circuitry, wherein the instructions, when executed by at least one processor, individually or in any combination, cause the electronic device to: collect at least one of information stored in an application installed in the electronic device, an event received through the application, information stored in the memory, and/or configuration information configured for the electronic device; determine a user's usage pattern by analyzing the collected information; generate prompt information to be provided to a generative artificial intelligence by analyzing the user's usage pattern; generate artificial intelligence (AI) notification information through the generative artificial intelligence, based on the prompt information; and provide the AI notification information when an action predicted through the generative artificial intelligence is not performed.

A method of operating an electronic device according to an example embodiment of the disclosure may include: collecting at least one of information stored in an application installed in the electronic device, information stored in a memory, and/or configuration information configured for the electronic device, determining a user's usage pattern by analyzing the collected information, an operation of generating prompt information to be provided to a generative artificial intelligence by analyzing the user's usage pattern, an operation of generating artificial intelligence (AI) notification information through the generative artificial intelligence, based on the prompt information, and providing the AI notification information when an action predicted through the generative artificial intelligence is not performed.

According to an example embodiment, a reminder of a task that needs to be performed by a user is provided although the user neither directly registers a schedule nor sets an alarm.

According to an example embodiment, a reminder of an operation that a user intends to perform currently, an operation that the user intended to perform but forgot, or an operation that would be good for the user to perform is provided.

According to an example embodiment, an electronic device may analyze a user's usage pattern, intention, or preference, predict a schedule desired by the user, and automatically provide a guide, based on various pieces of information stored in the electronic device.

According to an example embodiment, when it is determined that provision of a reminder is currently inappropriate, a reminder time may be adjusted to a time suitable for a user to perform a corresponding operation, based on a usage pattern of the user or the current usage state of an electronic device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIG. 2 is a diagram illustrating an example in which an electronic device provides a reminder based on a usage pattern according to various example embodiments.

FIG. 3 is a flowchart illustrating an example method of operating an electronic device according to various example embodiments.

FIG. 4 is a diagram illustrating an example configuration of generating AI notification information, based on collected information in an electronic device according to various example embodiments.

FIG. 5 is a flowchart illustrating an example method in which an electronic device collects various pieces of information according to various example embodiments.

FIG. 6 is a diagram illustrating an example in which an electronic device provides AI notification information according to various example embodiments.

FIGS. 7A, 7B and 7C are diagrams illustrating examples in which an electronic device provides AI notification information according to various example embodiments.

FIG. 8 is a flowchart illustrating an example method in which an electronic device provides AI notification information according to various example embodiments.

FIG. 9 is a diagram illustrating an example in which an electronic device displays AI notification information according to various example embodiments.

FIGS. 10A and 10B are diagrams illustrating an example in which an electronic device displays AI notification information according to various example embodiments.

FIG. 11 is a diagram illustrating an example in which an electronic device displays AI notification information according to various example embodiments.

FIG. 12 is a block diagram illustrating an example configuration of a generative artificial intelligence system according to various example embodiments.

### DETAILED DESCRIPTION

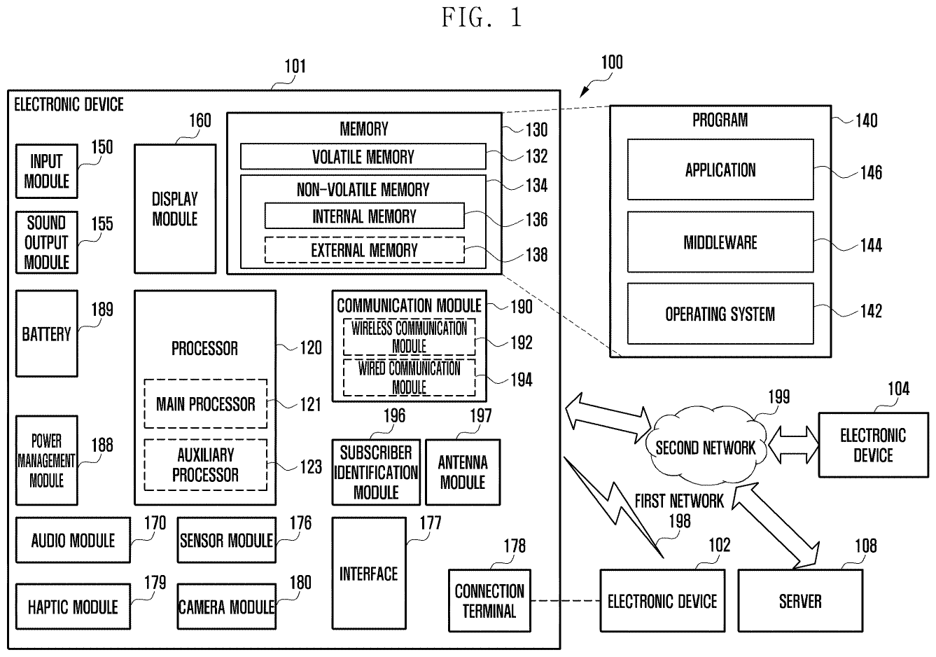

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used herein, the term “module” may include a unit implemented in hardware, software, or firmware, or any combination thereof, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

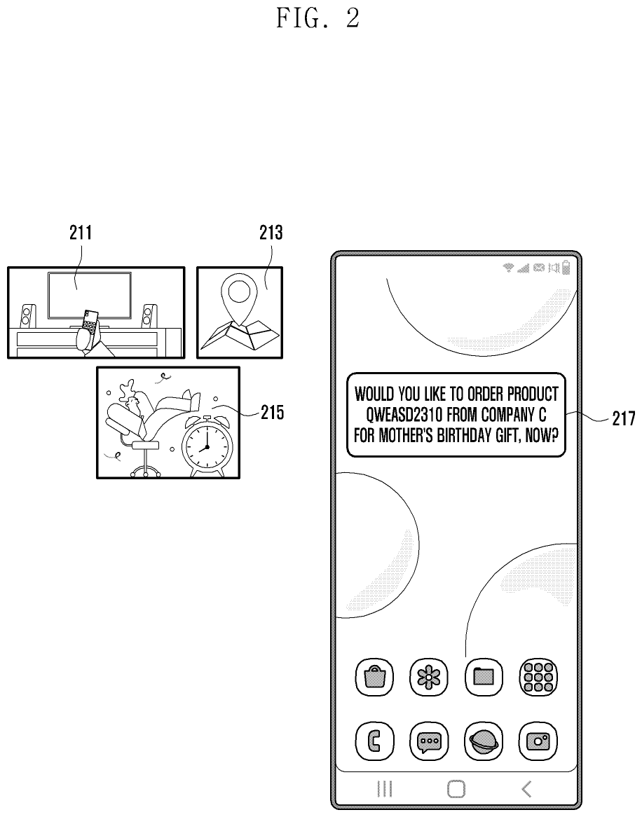

FIG. 2 is a diagram illustrating an example in which an electronic device provides a reminder based on a usage pattern according to various example embodiments.

Referring to FIG. 2, a processor (e.g., the processor 120 in FIG. 1) of an electronic device (e.g., the electronic device 101 in FIG. 1) according to an embodiment may determine a user's operation (or action) pattern by analyzing information stored in the electronic device 101 or information acquired from an external device connected to the electronic device 101. The information stored in the electronic device 101 may include information stored (or registered) in an application installed in the electronic device 101, information registered in a configuration of the electronic device 101, and information stored in a memory (e.g., the memory 130 in FIG. 1) of the electronic device 101. For example, the information stored in the application may include schedule information stored in a schedule application, conversation information stored in a messenger application, alarm information stored in an alarm application, documents stored in a document application (e.g., Word, Excel, PDF), and contact information stored in a contact information application. The above-described examples are for the purpose of assisting in understanding of the disclosure, and the disclosure is not limited to the examples.

The information registered in the configuration of the electronic device 101 may include, for example, connection information (e.g., Wi-Fi and Bluetooth), connection information with an external device, a mode/routine, sound/vibration, and a screen brightness, as configuration information of the electronic device 101. The information stored in the memory 130 may include a downloaded image, video, audio, document, installation file, sensing information, or a usage record of an application (e.g., when and how much it is used). The sensing information may be a measurement value obtained from a sensor module (e.g., the sensor module 176 in FIG. 1) included in the electronic device 101. The external device may include, for example, and without limitation, an Internet of Things (IoT) device such as a washing machine, a TV, a refrigerator, or a Bluetooth speaker, a wearable device such as a Bluetooth earphone, an external electronic device such as a laptop or a computer, etc. The information acquired from the external device may include, for example, and without limitation, an identifier of the external device, a notification (e.g., a washing completion notification) of the external device, a state (e.g., a power saving mode) of the external device, data (e.g., an image, a file, or favorite information) stored in the external device, etc. The processor 120 may determine an operation (or action) pattern of the user by collecting and analyzing information stored (or registered) in an external server (e.g., a cloud server) with which a user account of the electronic device 101 is registered.

The processor 120 may collect (or acquire) and analyze screen information (or content) (e.g., an application execution screen, a home screen) displayed on a display (e.g., the display module 160 in FIG. 1), and collect (or acquire) and analyze location information of the electronic device 101 using the connection information or GPS information of the electronic device 101, so as to identify an action performed by the user at a predetermined time at a particular location. For example, the user may wake up at 7 AM from Monday to Friday (e.g., location: home, alarm information analysis), move to another location (e.g., an office) from 8 AM to 9 AM (e.g., location change, transportation card records), buy coffee at AA (e.g., credit card records), eat lunch from 12 PM to 1 PM (e.g., credit card records), move to home from 6 PM to 7 PM, and watch TV or use a computer (e.g., game) from 7 PM to 12 AM at home. When the user changes a location, buys a product, or stays at home, the electronic device 101 is always carried by the user, and thus the processor 120 may determine the user's usage pattern using all information (e.g., the usage pattern of the electronic device 101) acquired through the electronic device 101.

The processor 120 may recognize current location information 213 (e.g., home) of the electronic device 101 using a record (e.g., screen mirroring) 211 of the electronic device 101 connected to an external device (e.g., TV) in a home or Wi-Fi connection information in the home. The processor 120 may collect alarm information stored in the alarm application or schedule information 215 stored in the schedule application at the current location.

The processor 120 may include a prompt generation module that generates a prompt specialized through a repetitive writing and evaluation, so as to generate a prompt for acquiring an optimized result from a generative AI. The processor 120 may generate prompt information through the prompt generation module. The generative AI may be included in the electronic device 101 or included in an external server. The generative AI may refer to an artificial intelligence neural network that generates a new type of data, based on user input information. The generative AI may refer, for example, to a model trained to output a statistically optimal output value based on an input value, and examples thereof include models such as CHAT-GPT 3 and CHAT-GPT 4. The generative AI may recognize various types of data inputs such as a character, an image, and voice, and generate new data corresponding thereto, and thus may be referred to as a large language model (large multimodal model; LLM).

The large language model may refer to an artificial neural network-based language model trained on a large amount of text data via pre-training. The large language model may include much more parameters (e.g., more than 10 billion) than the conventional general language model. The large language model may use a transformer artificial neural network structure based on an attention mechanism. The attention mechanism is a technology that helps an AI model to focus (attention) on an important part within input data. The attention mechanism may predict a degree to which a part of time-series input data (e.g., input data such as voice or video, or input data of some layers of a neural network) contributes to an intermediate or final neural network output, and use the same to predict output data. A recurrent neural network (RNN) structure that processes each element of a sequence sequentially may have reduced performance in prediction when information dependency in a long time series distance exists. The attention mechanism may consider the information dependency in the long time series distance by controlling a degree of weight concentration (attention) in the context of the input data (or part of the input data).

The transformer may be configured as an encoder-decoder structure. The encoder may process input data and outputs compressed information (e.g., contextual representation), and the decoder may process compressed information to output output-data in units of tokens. Each of the encoder and the decoder may include an independent attention network, and may include a cross-attention network connecting the encoder and the decoder.

For example, LLM training may include pre-training and/or fine-tuning. The pre-training may refer to a process of acquiring general language knowledge using a large amount of text data and may include, for example, self-supervised learning for predicting a next word using a previous word sequence of a text sequence. The fine-tuning may refer to a process of training an LLM to be suitable for a predetermined domain (e.g., chatbot, translation, summarization, Q&A) or task, and the LLM may be further trained through supervised (or adapted) learning using a dataset suitable for a purpose of the domain, based on a pre-trained model. The LLM may perform a task using a prompt, e.g., a text input that includes a natural language.

For example, the fine-tuning may be omitted during LLM training. In order to increase the performance of a task desired by the user, a prompt to be input to the LLM may be controlled. In a manner such as in-context learning or zero-shot/few-shot learning, an example of a task and/or a guide for performing a task may be additionally provided in the prompt. As publicly known LLMs, there are Bidirectional Encoder Representations from Transformer (BERT) and Generative Pre-trained Transformer (GPT), and the like.

The term “LLM” may refer to a language neural network model itself, but may also refer to a model of an LLM-based application (e.g., chatbot, translation, summarization, text classification, and sentence generation). For example, an LLM-based chatbot such as ChatGPT or an LLM-based translator may also be referred to as an “LLM.” The LLM may include an inference engine using an LLM neural network model. For example, “inputting an input prompt to an LLM” may be “inputting an input prompt to an LLM-based inference engine.” For example, “the LLM's output for the input prompt” may refer to output information of a last neural network layer of the LLM, obtained by inputting the input prompt to the LLM-based inference engine.

The processor 120 may generate prompt information to be provided to the LLM, based on the collected information. Since inputs and outputs exist, what prompt information has provided an optimally satisfactory result may also be trained. A process of training prompt information is performed in advance, and the generative AI trained on the prompt information may be included in the electronic device 101. The processor 120 (e.g., an AI processor, a trained library) including the generative AI may generate optimized prompt information, based on the collected information. The processor 120 including the generative AI may generate AI notification information 217, based on the prompt information.

For example, the AI notification information 217 may provide, to the user, a guide regarding an operation that the user intends to perform, an operation that the user intended to perform but forgot, or an operation that would be good for the user to perform. In the schedule application of the electronic device 101, the mother's birthday is stored as schedule information for three days later from the current time, and the mother may be stored in the contact application under a name of “mother”. The mother's contact information is configured in a “family” group, and another contact information (e.g., younger sibling's name) may be stored in the same family group. The processor 120 may analyze keywords such as “mother,” “birthday,” and “gift” from content of conversation with the younger sibling (e.g., conversation information stored in the messenger application) in the afternoon today, analyze the schedule information (e.g., mother's birthday in three days), and determine that a gift for the mother's birthday has not yet been purchased by referring to card records. The processor 120 may provide the AI notification information 217 when a home screen of the electronic device 101 is displayed on the display module 160 for a predetermined time (e.g., 1 minute, 3 minutes) in home which is the current location. The processor 120 may provide the AI notification information 217 as reminder information before the user falls in sleep, when the user arrives at home and a movement of the electronic device 101 is not detected for a predetermined time (e.g., 5 minutes, 10 minutes). The disclosure is provided to help the user when the user is expected to perform a necessary operation but does not perform the operation, and the above examples are for helping in understanding of the disclosure, and are not intended to limit the scope of the disclosure.

When the accuracy of a notification decreases, the user may recognize the notification as spam. Therefore, providing much information to the generative AI may be helpful when the generative AI generates prompt information or AI notification information. For example, the processor 120 may collect the current time as 17:20, location information as the Tottenham stadium in London, a connected external device as a friend's car (or a headset), activity information as stopped (e.g., no movement of the electronic device), recent conversation/message content (e.g., “card payment related content” and “recent message content with a friend”), stored user's schedule information (e.g., the calendar application—2024.01.22 18:00 to 20:00 football game viewing, (Tue) 2024.01.23 09:30 visit to parents'house, AAA application—2024.01.28 09:00 to 10:00, 2024.01.29 schedule B), BBB application (e.g., schedule D to schedule E)), some of a preference list (preference: YouTube, front seat, discount coupons, football, beer, Son Heung-Min, Lee Kwan-hui, Starbucks, lager; non-preference: fast food, overconsumption, Arsenal, ketchup, baseball, red-colored clothing, soju, rainy days, Netflix, expressways, . . . ), and the current application in use (e.g., a navigation application's trip completion screen, a music streaming application's execution screen, and a messenger application's chat screen with friend OO). The preference list may be distinguished by measuring scores of consent/nonconsent in conversation content of the messenger application, and may select a preferred person by analyzing stored images. For example, the processor 120 may identify a color of a photo and an object of a photo mainly from a food photo, an activity photo, and a downloaded photo, and identify preference or non-preference.

The processor 120 may display a product code (e.g., QWEASD2310) included in the AI notification information 217, to be distinguished from other texts. The processor 120 may display the product code to blink or to be bold (or shaded) than other texts. When the product code is selected by the user, the processor 120 may guide the user to easily buy the mother's birthday gift through the AI notification information 217 by executing a shopping application that sells a product corresponding to the selected product code. For example, the processor 120 may display an execution screen of the shopping application including a page for selling the product corresponding to the product code, and may blink a “product purchase button” or provide text such as “buy now” in the execution screen of the shopping application. The AI notification information 217 may include at least one of text, audio, an image, or video. The AI notification information 217 may be displayed on the display module 160 or output as voice through a speaker (e.g., the sound output module 155 in FIG. 1). The AI notification information 217 may include a user action guide, and the user action guide may be related to user interaction which may be a guide related to a touch position, a long press, a drag, a scroll, a double click, a swipe, or a swipe direction.

The electronic device 101 according to an example embodiment of the disclosure may include the display 160, the memory 130 storing instructions, and the processor 120, when the instructions, stored in the memory, are executed by the processor may cause the electronic device to: collect at least one of information stored in an application installed in the electronic device, information stored in the memory, an event received via the application, information stored in the memory, or configuration information configured in the electronic device; determine a usage pattern of a user by analyzing the collected information; generate prompt information to be provided to a generative artificial intelligence (AI) by analyzing the usage pattern of the user; generate AI notification information via the generative AI, based on the prompt information; and provide the AI notification information when an action predicted via the generative AI is not performed.

The instructions, when executed by the processor, may cause the electronic device to generate the prompt information related to a user action, based on at least one of the current state of the electronic device, content displayed on the display, conversation content of a messenger application, conversation content of an SNS application, a user action collected at a predetermined time, or the user's preference.

The instructions, when executed by the processor, may cause the electronic device to display, as the AI notification information, an indicator providing a guide for execution of a predetermined application, execution of a predetermined function of an application, or user interaction.

The instructions, when executed by the processor, may cause the electronic device to generate new AI notification information, based on an operation state of the electronic device by the user, when a user input with respect to the displayed AI notification information is not detected.

The instructions, when executed by the processor, may cause the electronic device to not provide the AI notification information to the user based on the current state of the electronic device, content displayed on the display, or the current user action, after generating the AI notification information, and delete the AI notification information.

The instructions, when executed by the processor, may cause the electronic device to: update the usage pattern of the user, based on a user action with respect to the electronic device, when a user input with respect to the displayed AI notification information is not detected; and generate new prompt information to be provided to the generative AI by analyzing the updated usage pattern of the user.

The instructions, when executed by the processor, may cause the electronic device to determine the usage pattern of the user by analyzing the current time, the current operation state of the electronic device, location information of the electronic device, or information obtained from an external server with which a user account of the electronic device is registered or an external device connected to the electronic device.

The instructions, when executed by the processor, may cause the electronic device to determine the usage pattern of the user by learning content displayed on the display at a predetermined time and a user action with respect to the electronic device.

The instructions, when executed by the processor, may cause the electronic device to provide the AI notification information when at least one of the current time, the current operation state of the electronic device, or location information of the electronic device corresponds to a condition for provision of the AI notification.

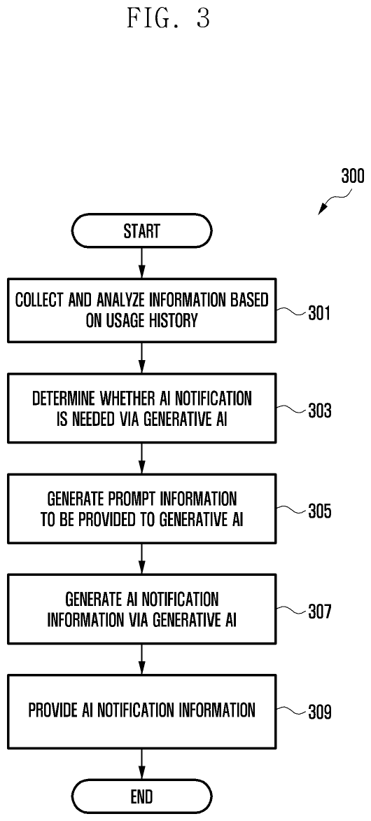

FIG. 3 is a flowchart 300 illustrating an example method of operating an electronic device according to various example embodiments.

Referring to FIG. 3, in operation 301, a processor (e.g., the processor 120 in FIG. 1) of an electronic device (e.g., the electronic device 101 in FIG. 1) according to an embodiment may collect and analyze information, based on a usage history. The usage history may refer to what application a user uses, a time when the application is used, or how much the application is used at a particular location. The usage history may include not only a time when the application is used but also what the user did after turning on the application. In which situation (e.g., time, location, display state) which application is turned on to perform which operation may be grouped and added to the usage history. Application internal information may be information stored in (or registered in) the application, and may include, for example, conversation information stored in a messenger application, schedule information stored in a schedule application, alarm information stored in an alarm application, documents stored in a document application, and contact information stored in a contact application. The application internal information may include a location and content information of a photo stored in a gallery application. For example, the processor 120 may recognize a preferred sport, a co-traveler, a preferred place, or preferred food information from the stored image.

The processor 120 may analyze information collected from the application. The processor 120 may analyze information collected from the application for a predetermined time, such as one day, one week, or two weeks, and analyze which application is used, and when, where, and how much the application is used. The processor 120 may analyze an operation that the user performs when an event is received from the application. The processor 120 may determine the user's usage pattern by analyzing information collected from the application through the generative AI. The user's usage pattern may be an action performed by the user at a predetermined time or a predetermined location. The action performed by the user may include, for example, reproducing music through a wireless earphone using a music application while traveling on a subway, or performing a predetermined function of a predetermined application. The processor 120 may learn the user's usage pattern and analyze the user's intention or preference, based on the information collected from the application. The processor 120 may learn the user's usage pattern, and learn the user's intention or the user's preference.

In operation 303, the processor 120 may determine whether there is a need for an AI notification via the generative AI. The generative AI (or a generative AI engine) may be included in the electronic device 101. The generative AI may be an artificial intelligence neural network that generates a new type of data, based on user input information. The generative AI is a model trained to output a statistically optimal output value based on an input value, and representatively, a large language model (LLM) may be used. The processor 120 may determine whether the AI notification is necessary through the generative AI only via operation 301. Operation 303 may be omitted.

The generative AI may generate a prediction list for an operation to be performed by the user at the current time, based on the user's usage pattern. The prediction list includes schedule information, for example, the generative AI may recognize that the user of the electronic device 101 usually does shopping at home after work by referring to the user's usage pattern. The generative AI may collect, from the messenger application, information that the user expressed an intention to purchase product B in a previous conversation with the other party A, and the other party A informed that using application C when purchasing product B would provide a discount benefit. The generative AI may predict an operation (e.g., purchase of product A using application C) to be performed under a predetermined condition (e.g., no schedule registered, 7 PM, home). The AI notification may be a time-based or condition-based notification. The generative AI may determine which one between the time-based notification or the condition-based notification is to provide an optimized notification.

When the user does not perform an operation included in the prediction list, the processor 120 may determine that the AI notification is needed through the generative AI. For example, although it is registered to “purchase product A using application C at home at 7:00 PM when no schedule is registered,” if a similar-colored product is purchased at an earlier time or if the user expresses a change of the intention of purchase in conversation with the other party A, the generative AI may consider it as intentional schedule cancellation. When the generative AI determines, from the sensing information of the electronic device 101, that a bicycle ride or long-distance driving is in progress, the generative AI may determine that the schedule is unintentionally canceled and may change a time for the AI notification. The example is only for the purpose of helping in understanding of the disclosure, and is not intended to limit the disclosure.

The generative AI may determine whether the AI notification is necessary, based on (1) conversation context: when a core subject identified from conversation context and keywords in a message, SNS, or the like matches the user's preference, (2) a schedule: when a time corresponds to a schedule or a notification registered by the user or the generative AI, (3) a location: when a location (by referring to a connected device (car), location information (Wi-Fi, GPS), payment information, or conversation content, or the like) matches the user's preference or the user's application usage pattern (e.g., it is identified that the user is at the London Tottenham stadium, or it is determined that the user is at his/her parents' house), and (4) others: when an external device is disconnected/registered (car disconnection, TV disconnection), when a battery (e.g., the battery 189 in FIG. 1) of the electronic device 101 drops to a predetermined level or lower, or when the electronic device 101 is not used for a predetermined time (1 hour).

In operation 305, the processor 120 may generate prompt information to be provided to the generative AI. When the accuracy of a notification decreases, the user may perceive the notification as spam. Therefore, providing much information to the generative AI may be helpful when the generative AI generates the prompt information or AI notification information. For example, the processor 120 may transfer the current time (17:20), a location (e.g., London Tottenham stadium), a connected external device (e.g., a friend's car or a headset), activity information (e.g., stopped), stored user's schedule information (e.g., a calendar application—1.22 18:00 to 20:00 football game viewing), preference information (e.g., preference: YouTube, front seat, discount coupon, football, beer; non-preference: fast food, Arsenal, ketchup, baseball, red-colored clothing), and a currently used user application (e.g., navigation application's trip completion screen) to the generative AI, and may generate a prompt such as “Please recommend a task to do right now. If an immediate recommendation is needed, let me know, and if it is not needed right now, register it as a schedule.” Alternatively, when the prompt information is a condition (e.g., a change of a place, execution of a predetermined application, initiation of predetermined conversation, or idle state continued in one hour) other than time, prompt information such as “Register a routine to provide information at a corresponding time, and also determine and register the number of repetitions.” may be generated.

In operation 307, the processor 120 may generate AI notification information through the generative AI. The generative AI may generate the AI notification information, based on the prompt information. For example, when the user arrives at stadium AA registered as schedule information, the generative AI may generate AI notification information such as “You have arrived at the stadium. You can get a ticket at the main entrance. Please prepare a discount coupon”. When the user selects the AI notification information, the generative AI may generate AI notification information for finding a discount coupon, such as “home screen→gallery→coupon photo album→discount coupon.” The generative AI may generate AI notification information, such as “gallery? coupon photo album? discount coupon,” at the main entrance of stadium AA. When there is no beer purchase history when the user enters the third floor of stadium AA, the generative AI may generate AI notification information such as “It seems that you have not bought any beer yet. You can purchase OO lager on the second floor.” According to an embodiment, the processor 120 may transmit the prompt information to an intelligent server (e.g., the server 108 in FIG. 1) through a communication module (e.g., the communication module 190 in FIG. 1) and receive the AI notification information from the server 108.

In operation 309, when an action predicted via the generative artificial intelligence is not performed, the processor 120 may provide the AI notification information. When the current location of the electronic device 101 is “AA stadium main entrance,” and the user does not move to a ticket issuance place or does not get a ticket issued, the processor 120 may provide AI notification information such as “You have arrived at the stadium. You can get a ticket at the main entrance. Please prepare a discount coupon.” When a user input for selecting the AI notification information is detected, the processor 120 may provide AI notification information which provides a guide in the order of “gallery? coupon photo album? discount coupon” on a screen, as a detailed guide regarding whether the discount coupon is, for the user who does not remember where the discount coupon is stored. The processor 120 recognizes that the user is on the third floor of stadium AA, based on Wi-Fi connection, the current location, altitude information, and conversation content with a friend, but when a card payment text message associated with beer OO does not exist, the processor 120 may provide AI notification information such as “You seem to have not bought beer yet. You can buy OO lager at the second floor.

The processor 120 may generate prompt information, based on the information collected and analyzed in real time, and may remove, add, or change the AI notification information at any time, based on the prompt information using the generative AI. The AI notification information may include at least one of text, audio, an image, and video. The processor 120 may display the AI notification information on the display module 160, or output voice regarding the AI notification information through a speaker (e.g., the sound output module 155 in FIG. 1). In a state in which the electronic device 101 is connected to an external device such as a wearable device, the AI notification information may be provided through the wearable device.

According to an embodiment, the processor 120 may provide the AI notification information when receiving a reminder request from the user. The processor 120 may provide the AI notification information when a designated voice command (e.g., “reminder”) is input, a designated button (e.g., a voice recognition service button) is selected, or designated text (e.g., “Please give me a reminder”) is input.

According to an embodiment, the processor 120 may update the usage pattern of the user, based on a user action with respect to the electronic device 101, when a user input with respect to the displayed AI notification information is not detected. When no user input with respect to the AI notification information is detected, the AI notification information may not be AI notification information desired by the user. In this case, the processor 120 may update the user's usage pattern so as to generate AI notification information that more accurately reflects the user's intention.

According to an embodiment, when no user input with respect to the displayed AI notification information is detected, the processor 120 may generate new prompt information, based on the current state of the electronic device 101, screen information (or content) displayed on the display module 160, or the current user action. In order to generate new AI notification information that reflects the user's intention, the processor 120 may generate the new prompt information.

According to an embodiment, when no user input with respect to the AI notification information is detected, the processor 120 may generate the new AI notification information, based on an operation state of the electronic device 101 by the user. When no user input with respect to the AI notification information is detected, the processor 120 may determine that the AI notification information does not recognize the user's intention and generate the new AI notification information.

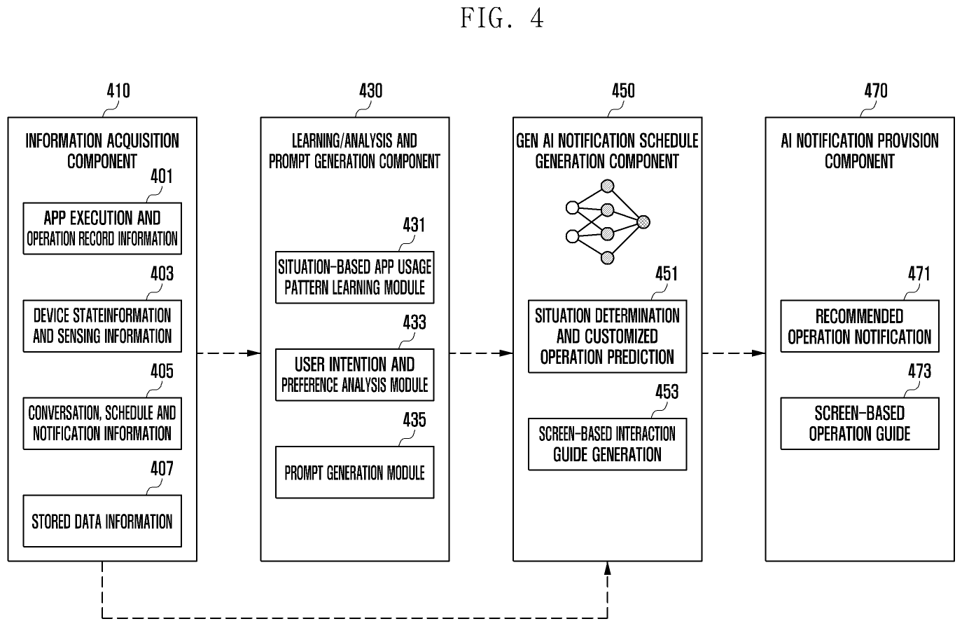

FIG. 4 is a diagram illustrating an example configuration of generating AI notification information, based on collected information in an electronic device according to various example embodiments.

Referring to FIG. 4, an electronic device (e.g., the electronic device 101 in FIG. 1) according to an embodiment may include an information acquisition component 410, a learning/analysis and prompt generation component 430, a Gen AI notification schedule generation component 450, and an AI notification provision component 470. The information acquisition component 410 may directly transfer acquired (or collected) information to a prompt generation module 435, or transfer the same to the prompt generation module 435 through a situation-based app usage pattern learning module 431 or a user intention and preference analysis module 433. The Gen AI notification schedule generation component 450 may be included in a generative AI. The learning/analysis and prompt generation component 430 and the AI notification provision component 470 may or may not be included in the generative AI. The generative AI may generally refer to an artificial intelligence neural network that generates a new type of data based on user input information. The generative AI may be a model trained to output a statistically optimal output value, based on an input value.

The information acquisition component 410 may include app execution and operation record information 401, device state information and sensing information 403, conversation, schedule and notification information 405, and stored data information 407. The app execution and operation record information 401 may be record information regarding when, where, and how long an application is used. The device state information and sensing information 403 may include a communication connection state (e.g., Wi-Fi, Bluetooth) of the electronic device 101, information on when, where, and with which external device the electronic device 101 is connected, and sensing information measured by a sensor module (e.g., the sensor module 176 in FIG. 1) of the electronic device 101. The conversation, schedule and notification information 405 may refer to information stored in the application. For example, the conversation, schedule and notification information 405 may include conversation information stored in a messenger application, schedule information stored in a calendar application, alarm information stored in an alarm application, an image (or video) stored in a gallery application, and a post stored (or registered) in a posting application. The stored data information 407 may include various pieces of information stored in a memory (e.g., the memory 130) of the electronic device 101, other than applications. For example, the stored data information 407 may include information such as a mode/routine, sound/vibration, and screen brightness.

The learning/analysis and prompt generation component 430 may include the situation-based app usage pattern learning module 431, the user intention and preference analysis module 433, and the prompt generation module 435. The situation-based app usage pattern learning module 431 relates to an operation that a user mainly performs for each time and/or location. For example, the situation-based app usage pattern learning module 431 may store an operation performed by the user in the electronic device 101, and may define and classify the operation performed by the user based on a purpose. The situation-based app usage pattern learning module 431 may define and classify a usage pattern using a trained library or module. The situation-based app usage pattern learning module 431 may classify a user action and obtain a pattern, and may use a library or module included in the memory (e.g., the memory 130 in FIG. 1) of the electronic device 101. The generative AI that implements the disclosure may be trained and included in the library or module. An AI learning technique such as machine learning may be used as a learning method.

The user intention and preference analysis module 433 may analyze, based on the usage pattern, what operation the user is to perform, what the user likes (e.g., a dog, a plant), and what the user dislikes (e.g., exercise). The prompt generation module 435 may generate prompt information for requesting generation of AI notification information regarding a task that the user must do, a task that the user should do, or a task that the user needs to do by monitoring whether the user has a task to do at the current time, considering the trained usage pattern, the trained user's intention or preference. The more accurate the prompt information is, the more accurate the AI notification information may be generated.

The Gen AI notification schedule generation component 450 may include a situation determination and customized operation prediction 451 and a screen-based interaction guide generation 453. The situation determination and customized operation prediction 451 may determine the current situation of the electronic device 101, that is, may determine where the electronic device 101 is currently located, based on connection information or location information of the electronic device 101, whether the user is currently using the electronic device 101, based on sensing information of the electronic device 101, and what the user is currently viewing, based on screen information (or content) displayed on the display module 160. The situation determination and customized operation prediction 451 may predict an operation that the user needs to perform or a recommended operation, based on the determined current situation. For example, the recommended operation may include recommending a movie of about 2 hours, when the user is looking at a home screen of the electronic device 101 at 10 PM, in consideration of the user's bedtime (e.g., 12 AM). When the user does not make a purchase even after performing a washing machine operation (detergent consumption), the operation of providing a notification may include generating a prompt based on the washing machine operation and detergent shortage, generating a notification (result) that predicts a need for the user to purchase detergent through the generative AI, and providing the notification if the user does not purchase the detergent for a predetermined period of time.

The Gen AI notification schedule generation component 450 may generate AI notification information, based on the prompt information. Although a laundry detergent search is conducted, if it is expected that the detergent is still remaining, based on a previous purchase history and a washing machine usage pattern, the Gen AI notification schedule generation component 450 may generate AI notification information indicating that the laundry detergent needs to be purchased later, based on the remaining amount of the laundry detergent. The Gen AI notification schedule generation component 450 may determine a usage pattern of the user, generate prompt information based on the usage pattern, and generate AI notification information based on the prompt information.

The AI notification information may include not only a guide for an operation, but also a guide for the user's interaction. The screen-based interaction guide generation 453 may generate user interaction, such as a guide for a touch position, a long press, a drag, a scroll, a double click, a swipe, or a swipe direction, as AI notification information.

The AI notification provision component 470 may include a recommended operation notification 471 and a screen-based operation guide 473. Based on the AI notification information, the recommended operation notification 471 may provide AI notification information that is appropriate for the current situation of the electronic device 101. Based on the AI notification information, the screen-based operation guide 473 may provide AI notification information suitable for the current time, location, or situation. The AI notification information may differ for each application and for each function within the application. The screen-based operation guide 473 may display an indicator (e.g., an arrow or text) providing a guide for an operation to be performed by the user for each screen, based on the AI notification information. When no purchase is made after a washing machine operation (detergent consumption), the AI notification provision component 470 may provide AI notification information indicating that the laundry detergent needs to be purchased. That is, the AI notification provision component 470 may provide AI notification information when an action predicted via the generative AI is not performed.

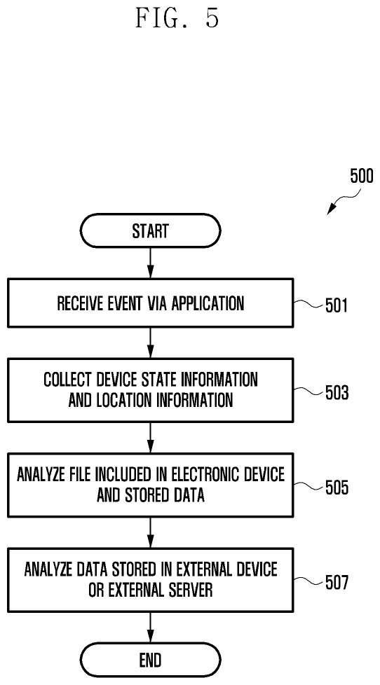

FIG. 5 is a flowchart 500 illustrating an example method in which an electronic device collects various pieces of information, based on an event according to various example embodiments. FIG. 5 may be a more detailed illustration of operation 301 and operation 303 in FIG. 3.

Referring to FIG. 5, in operation 501, a processor (e.g., the processor 120 in FIG. 1) of an electronic device (e.g., the electronic device 101 in FIG. 1) according to an embodiment may receive an event through an application. The event may include a push message of an application installed in the electronic device 101. For example, the event may be a message received from an application for IoT device control (e.g., Smart things), a message received from a messenger application, an advertisement received from a shopping application, a post notification received from an SNS application, or a discount notification received from application BB.

In operation 503, the processor 120 may collect device state information and location information. The device state information may include a communication connection state (e.g., Wi-Fi, Bluetooth) of the electronic device 101, when, where, and with which external device the electronic device 101 is connected, and sensing information measured by a sensor module (e.g., the sensor module 176 in FIG. 1) of the electronic device 101. For example, in a case in which there is an event to be identified in device B while device A is in use, when device A and device B are in the same space or device A and device B are connected in communication, and the event is not identified, a generative AI may provide AI notification information to device A, so as to indicate that the event in device B needs to be identified. The generative AI may generally refer to an artificial intelligence neural network that generates a new type of data, depending on user input information. The generative AI may be a model trained to output a statistically optimal output value, based on an input value. The processor 120 may collect the location information as to whether the electronic device 101 is at home or at an office, based on information acquired from a GPS module of the electronic device 101 and the communication connection state of the electronic device 101.

In operation 505, the processor 120 may analyze a file and/or stored data included in the electronic device 101. For example, the file or data may be stored in a memory (e.g., the memory 130 in FIG. 1) of the electronic device 101. The processor 120 may analyze conversation information stored in the messaging application, schedule information stored in a schedule application, alarm information stored in an alarm application, contact information stored in a contact information application, and a post stored (or registered) in a posting application as the file or data. The processor 120 may analyze the file or data to analyze a user's intention, pattern, or preference.

According to an embodiment, the processor 120 may collect and analyze, for each application, a main usage habit, a usage time, and a usage location. For example, usually, the electronic device 101 is connected to Wi-Fi AA, a screen of the electronic device is off at 8 PM., and a shopping application is used at 9 PM. The processor 120 may determine that the location information corresponds to a home when the electronic device 101 is connected to Wi-Fi AA, or may identify that the electronic device 101 is connected to Wi-Fi AA when the location information is determined as the home via the GPS module. The processor 120 may analyze when, where, and which application is used, according to a usage state of the electronic device 101.

The processor 120 may analyze preference information, based on the file or the data. For example, data stored in a food delivery application may include a restaurant name or type (e.g., Korean cuisine, Chinese cuisine, Japanese cuisine), a food menu (e.g., chicken, tteokbokki, jajangmyeon, spaghetti), a delivery time, and a payment method (e.g., cash, card). In addition, data stored in a card application may include a card usage history including a payment time, a location, a store name, and an amount. The processor 120 may analyze what the user prefers or does not prefer, based on the file or data.

In operation 507, the processor 120 may analyze data stored in an external device and/or an external server. The external device may include a washing machine, a TV, a refrigerator, an IoT device such as a Bluetooth speaker, a wearable device such as a Bluetooth earphone, or an external electronic device such as a laptop or a computer. Information acquired from the external device may include an identifier of the external device, a notification (e.g., a washing completion notification) of the external device, a state (e.g., a power saving mode) of the external device, or data (e.g., an image, a file, or favorite information) stored in the external device. The processor 120 may analyze the data stored in the external device to analyze the user's intention, pattern, or preference. The processor 120 may analyze the data stored in the external server (e.g., the server 108 in FIG. 1) such as a cloud server with which a user account of the electronic device 101 is registered, to analyze the user's intention, pattern, or preference. For recommendation, the processor 120 may refer to information associated with other users.

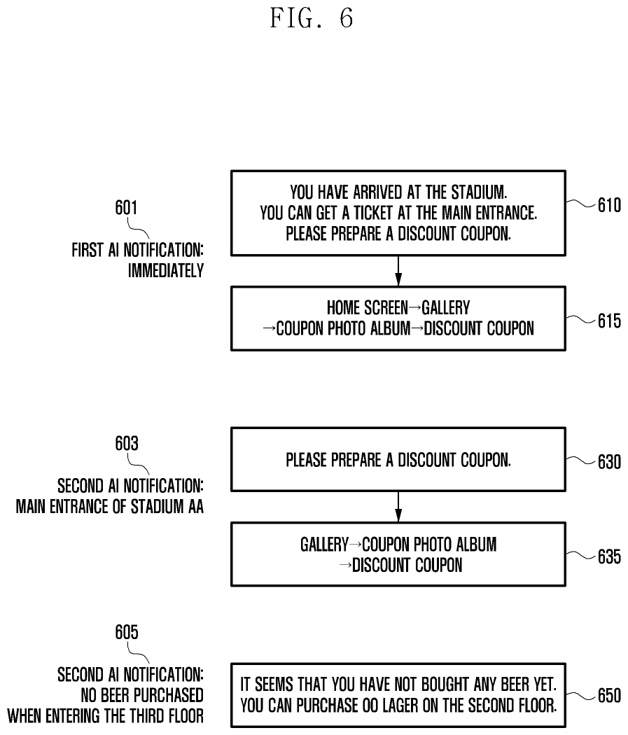

FIG. 6 is a diagram illustrating an example in which an electronic device provides AI notification information according to various example embodiments.

Referring to FIG. 6, a processor (e.g., processor 120 in FIG. 1) of an electronic device (e.g., the electronic device 101 in FIG. 1) according to an embodiment may provide AI notification information that differs depending on a state (e.g., situation, location) of the electronic device 101, the current time, or a condition, using a generative AI. The generative AI may be included in the electronic device 101. The generative AI may refer to an artificial intelligence neural network that generates a new type of data depending on user input information. The generative AI is a model trained to output a statistically optimal output value based on an input value, and may recognize various types of data inputs, such as a character, an image, and voice, and generate new data corresponding thereto.

The processor 120 may generate prompt information such as “Recommend a task to do right now” based on a connected external device (e.g., a friend's car, a headset), activity information: stopped, stored user's schedule information (e.g., a calendar application 18:00 to 20:00 football game viewing), preference information (e.g., preference: YouTube, front seat, discount coupon, football, beer, Son Heung-min, non-preference: fast food, overconsumption, Arsenal, baseball, soju, rainy days, Netflix, expressways), and the current application (e.g., a navigation application's trip completion screen) displayed on a display (e.g., the display module 160 in FIG. 1), using the generative AI.

The generative AI may generate a result (e.g., a first AI notification 601) based on the prompt information, and, based on the result to be generated, determine that the first AI notification 601 is needed when the electronic device 101 has arrived at stadium AA and does not perform any other operation, and may indicate, to the processor 120, provision of first notification information 610. The processor 120 may provide the first notification information 610 according to the indication by the generative AI. A condition for provision of the first AI notification 601 may be “immediately,” and the generative AI may indicate, to the processor 120, generation and immediate provision of the first AI notification information 610. A user may identify a task to do via the AI notification information 610. When the user selects the first AI notification information 610, the processor 120 may provide first AI notification information-2 615. The user may quickly find a discount coupon through the first AI notification information-2 615.

When the current location of the electronic device 101 is the main entrance of stadium AA, the generative AI may determine that a second AI notification 603 is required based on the prompt information, and may indicate, to the processor 120, provision of second AI notification information 630. The processor 120 may provide the second AI notification information 630 in accordance with the indication by the generated AI. The generative AI may indicate, to the processor 120, provision of the second AI notification information 630 different from the first AI notification information 610, based on the current state of the electronic device 101. A condition for provision of the second AI notification 603 may be “when arriving at the main entrance of stadium AA.” The user may identify a task to do right now via the second AI notification information 630, and purchase a football game ticket using the discount coupon. When the user selects the second AI notification information 630, the processor 120 may provide second AI notification information-2 635. The user may quickly find the discount coupon via the second AI notification information-2 635.

When the current location of the electronic device 101 is the third floor of stadium AA and an action of purchasing beer is not performed (e.g., no beer purchase history in a card history), the generative AI may determine that a third AI notification 605 is needed, and may indicate, to the processor 120, provision of third AI notification information 650. The processor 120 may provide the third AI notification information 650 according to the indication by the generative AI. A condition for provision of the third AI notification 605 may be “the third floor of stadium AA and no beer purchase history.” The generative AI may indicate, to the processor 120, provision of the third AI notification information 650 different from the second AI notification information 630, based on the current state of the electronic device 101. The user may identify a task to do now via the third AI notification information 650, and purchase beer.

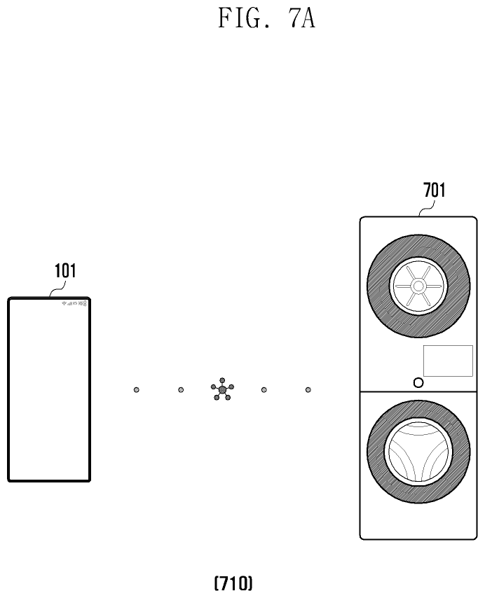

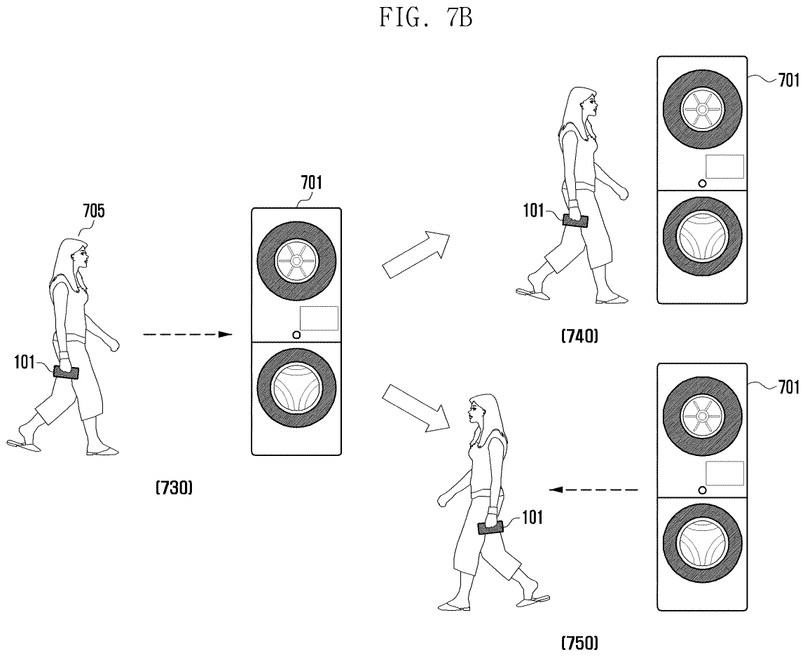

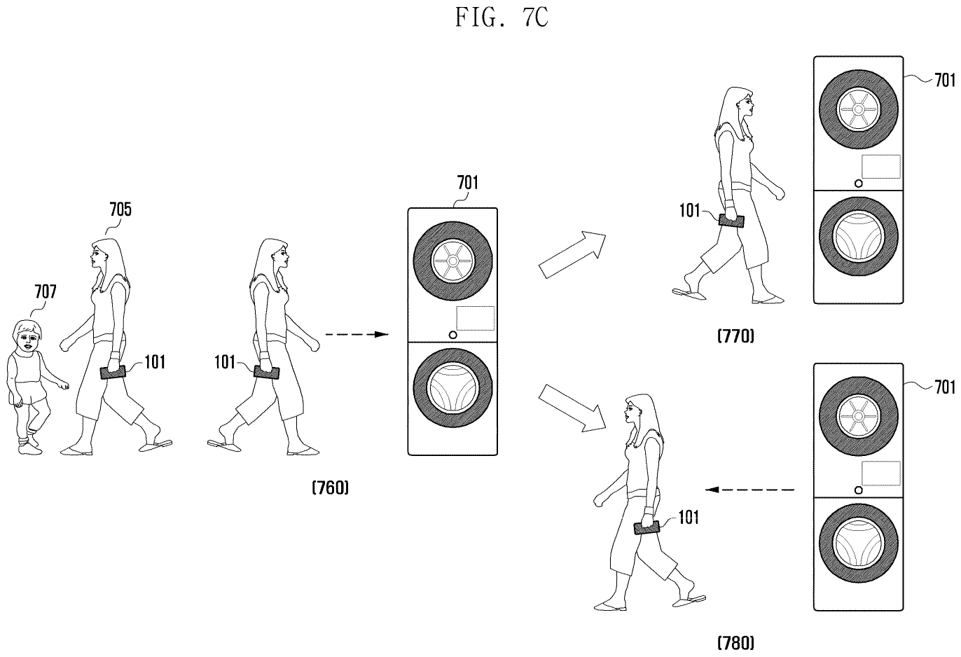

FIGS. 7A, 7B and 7C are diagrams illustrating examples in which an electronic device provides AI notification information according to various example embodiments.

Referring to FIG. 7A, in a first situation 710, a notification may be generated using a generative AI when an event is received, and the notification may be provided to a user when the user approaches a washing machine but does not perform any operation. An electronic device (e.g., the electronic device 101 in FIG. 1) may recognize a time in which the user uses an external device, a location, or a function, based on connection information with the external device and information acquired from the external device through an IoT control application. For example, the user may usually use a washing machine 701 on Wednesday, Thursday, or weekends at 8:00 PM. The user usually uses standard washing for the washing machine 701 and may use a washing drying machine after the washing machine 701. The electronic device 101 may transfer the user's usage pattern to the generative AI, and the electronic device 101 may generate prompt information, based on the user's usage pattern, the current state of the electronic device 101, and a notification received from the washing machine 701, using the generative AI. The generative AI may refer to an artificial intelligence neural network that generates a new type of data, depending on user input information. The generative AI may refer, for example, to a model trained to output a statistically optimal output value based on an input value, and may recognize various types of input data, such as a character, an image, and voice, and generate new data corresponding thereto.

The generative AI may generate AI notification information based on the prompt information, and may plan a time to provide the AI notification information. The plan may be modified in the middle. After the AI notification information is generated by the generative AI, when the user approaches the washing machine but does not perform any operation, the electronic device 101 may provide the generated AI notification information to the user, as shown in the drawing. A condition for provision of the AI notification information may be “immediately,” or after a predetermined time. When the generative AI determines that there is a blank time or a tea time is appropriate based on the user's schedule, the generative AI may generate AI notification information based on the generated prompt information and may indicate, to the processor 120, provision of the generated AI notification information. The condition for provision of the AI notification information may not be a time, but a predetermined (e.g., specified) condition. The condition for provision of the AI notification information may be a case of arriving at a predetermined place, such as a home or a cafe, may be a wake-up time, or may be a case in which boarding public transportation is recognized.

Referring to FIG. 7B, a second situation 730 may be an example in which AI notification information is generated based on a usage pattern, after a user 705 operates the washing machine 701. When the washing is completed, the washing machine 701 may transmit a washing completion notification to the electronic device 101. When the user comes near the washing machine but does not take out laundry, the generative AI may primarily generate AI notification information such as “Please take out laundry from the washing machine.” In a case where an operation predicted by the generative AI is not performed (e.g., when the user approaches the washing machine but does not take out laundry), the electronic device 101 may provide the AI notification information such as “Please take out laundry from the washing machine” primarily according an indication by the generative AI. After providing the AI notification information primarily, when the user does not take out the laundry from the washing machine (e.g., the user does not take out the laundry for a predetermined period of time), the electronic device 101 may regenerate prompt information for providing a push notification. The electronic device 101 may generate new prompt information to be provided to the generative AI when the user's location information is not changed even after a predetermined time (5 minutes) elapses, which is specified based on a washing completion event or the user's location information (near the washing machine). The generative AI may generate AI notification information such as “If you do not immediately retrieve the laundry from the washing machine, the laundry may be damaged, so please take out the laundry as soon as possible” based on the new prompt information.

According to the usage pattern, the user 705 needs to take out the laundry from the washing machine 701 and put them into the drying machine, but the electronic device 101 may identify that opening of the washing machine door is not detected or the drying machine does not operate within a predetermined time (e.g., 5 minutes, 10 minutes) after receiving the washing completion notification. When an action predicted via the generative AI is not performed, the electronic device 101 may provide the AI notification information indicating that the laundry needs to be taken out. The electronic device 101 may transfer the current situation to the generative AI when the laundry needs to be taken out quickly, based on a washing mode (wool, comforter, etc.). When the laundry does not need to be taken out quickly, the electronic device 101 may transfer the current situation to the generative AI. In this case, the generative AI may generate AI notification information for a case in which the laundry needs to be taken out quickly and AI notification information for a case in which the laundry does not need to be taken out quickly, differently. The generative AI may indicate, to the electronic device 101, provision of the AI notification information at different times for the case that the laundry needs to be removed quickly and the case that the laundry does not need to be removed quickly. The electronic device 101 may determine whether to provide AI notification information, when to provide AI notification information, or whether to update content of AI notification information using the generative AI.

The electronic device 101 may generate AI notification information indicating that the laundry needs to be put in the drying machine when the drying machine does not operate within a predetermined time after the washing completion notification is received. In the second situation 730 or before, the electronic device 101 may receive the washing completion event and may generate AI notification information using the generative AI. The electronic device 101 may not provide the AI notification information when the user 705 moves near the washing machine 701 as shown in a third situation 740, and provide the AI notification information generated using the generative AI to the user when the user 705 moves away from the washing machine 701 without any operation as shown in a fourth situation 750.

Referring to FIG. 7C, a fifth situation 760 may represent an example in which the user 705 has conversation with a third party 707. The electronic device 101 may not provide the AI notification information when the user 705 has conversation with the third party 707 as shown in the fifth situation 760. The electronic device 101 may perform an operation of providing the AI notification information generated using the generative AI when it is detected that the user moves near the washing machine 701. The electronic device 101 may not provide the AI notification information when the user 705 moves near the washing machine 701 as shown in a sixth situation 770, and may provide the AI notification information generated using the generative AI to the user 705 when the user moves away from the washing machine 701 without performing any operation as shown in a seventh situation 780.

In FIG. 7B and FIG. 7C, the user may wear a wearable device (e.g., a watch or a wireless earphone) connected to the electronic device 101. The electronic device 101 may output the AI notification information through the wearable device. The AI notification information may include at least one of text, audio, an image, or video.

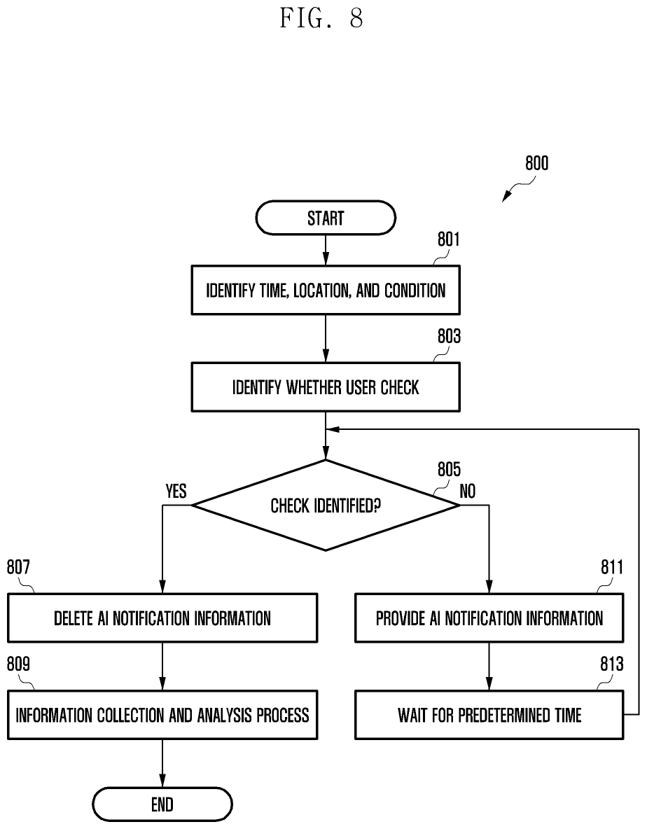

FIG. 8 is a flowchart 800 illustrating an example method in which an electronic device provides AI notification information according to various example embodiments.

Referring to FIG. 8, in operation 801, a processor (e.g., the processor 120 of FIG. 1) of an electronic device (e.g., the electronic device 101 of FIG. 1) according to an embodiment may identify a time, a location, and a condition. A generative AI may refer to an artificial intelligence neural network that generates a new type of data depending on user input information. The generative AI is a model trained to output a statistically optimal output value based on an input value, and may recognize various types of data inputs, such as a character, an image, and voice, and generate new data corresponding thereto. The generative AI may generate a prediction list of actions that a user needs to perform when at least one of the current time, the current location, or a predetermined condition corresponds to the user's usage pattern. The prediction list may include schedule information, for example, an operation (e.g., operating a washing machine) to be performed at a predetermined time (e.g., 7 PM) at a predetermined location (e.g., at home).

When the user does not perform an operation included in the prediction list, the generative AI may determine that an AI notification is necessary. The generative AI may generate prompt information regarding an operation requiring the user's action, based on information collected from the electronic device 101, an external device, an external server, or an application. The generative AI may generate AI notification information based on the generated prompt information.

In operation 803, the processor 120 may identify whether the user checks the same during a predetermined time. The processor 120 may identify whether the user performs an operation predicted via the generative AI, for example, an operation that the user must do, an operation that the user should do, or an operation that the user needs to do.

In operation 805, the processor 120 may determine whether the user checks the same. When the processor 120 identifies that the action predicted via the generative AI is performed by the user, the processor 120 may perform operation 807. When the processor 120 identifies that the action predicted via the generative AI is not performed by the user, the processor 120 may perform operation 811.

When identifying that the user performs the action predicted via the generative AI, the processor 120 may delete the AI notification information in operation 807. Since the user has performed the predicted operation, the processor 120 may delete the AI notification information. Alternatively, the processor 120 may provide recommendation information in the generated AI notification information, based on the current state of the electronic device 101. This is an implementation-related issue, and does not limit the disclosure.

In operation 809, the processor 120 may perform an information collection and analysis process. The information collection and analysis process may include operations 301 and 303 in FIG. 3, and operations in FIG. 5 or 6. In order to provide more accurate AI notification information, the processor 120 may collect and analyze information to determine the user's usage pattern, intention, and preference (or taste).

When it is identified that the user does not perform the action predicted via the generative AI, the processor 120 may provide the AI notification information in operation 811. The AI notification information may include an indicator providing a guide for execution of an application, execution of a predetermined function of an application, or a user interaction. The user may perform an operation that the user must perform, an operation that the user should perform, or an operation that the user needs to perform, by referring to the AI notification information. The AI notification information may include at least one of text, audio, an image, or video. The AI notification information may be displayed on a display (e.g., the display module 160 in FIG. 1) or output through a speaker (e.g., the sound output module 155 in FIG. 1).

In operation 813, the processor 120 may wait for a predetermined time. The processor 120 may wait for the predetermined time and determine whether a user input with respect to the AI notification information is detected. When a user input with respect to the AI notification information is detected, the processor 120 may determine that the user identifies the AI notification information in operation 805, and then perform operation 807. The processor 120 may update the user's usage pattern, based on a user action with respect to the electronic device 101, when a user input with respect to the AI notification information is not detected. When no user input with respect to the AI notification information is detected, the AI notification information may not be AI notification information desired by the user. In this case, the processor 120 may update the user's usage pattern so as to generate AI notification information that more accurately reflects the user's intention.

According to an embodiment, when no user input with respect to the AI notification information is detected, the processor 120 may generate new prompt information, based on the current state of the electronic device 101, screen information (or content) displayed on the display module 160, or the current user action. The processor 120 may generate the new prompt information in order to generate new AI notification information reflecting the user's intention.

According to an embodiment, when no user input with respect to the AI notification information is detected, the processor 120 may generate new AI notification information based on an operation state of the electronic device 101 by the user. When no user input with respect to the AI notification information is detected, the processor 120 may determine that the AI notification information does not recognize the user's intention and may generate the new AI notification information.

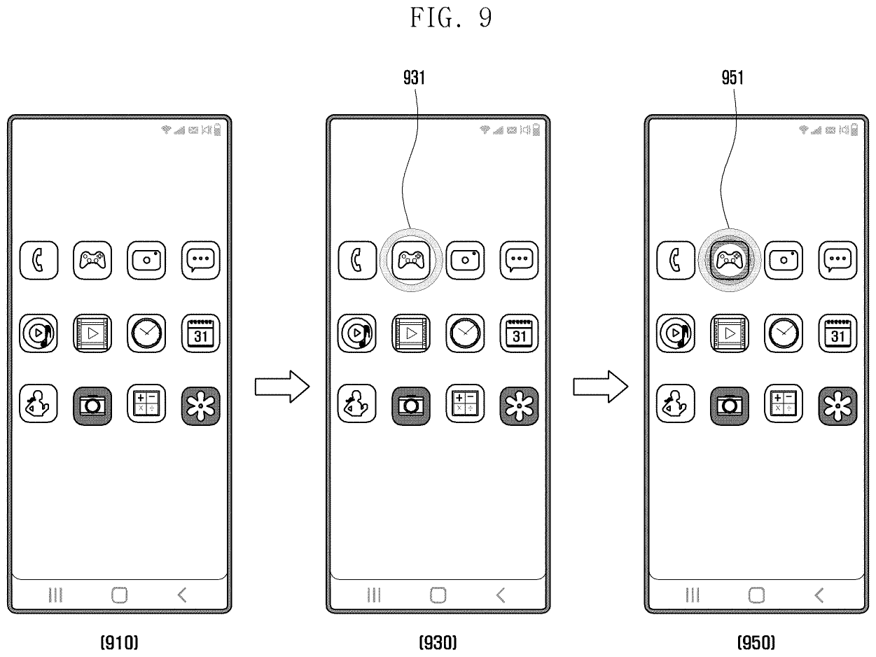

FIG. 9 is a diagram illustrating an example in which an electronic device displays AI notification information according to various example embodiments.

Referring to FIG. 9, a processor (e.g., the processor 120 in FIG. 1) of an electronic device (e.g., the electronic device 101 in FIG. 1) according to an embodiment may identify a user's usage pattern (e.g., identify a pattern based on various pieces of information via the usage-based app usage pattern learning module 431 or an AI module), predict that the user is to perform a predetermined operation using a generative AI, and provide AI notification information generated via the generative AI when the predicted operation is not performed. For example, in a state in which a first user interface 910 is displayed, when the user does not perform the operation predicted via the generative AI, a second user interface 930 or a third user interface 950 may be displayed on a display (e.g., the display module 160 in FIG. 1). The first user interface 910 may include a home screen of the electronic device 101. The second user interface 930 may be an example of providing first AI notification information 931 to the user via blinking. In addition, the third user interface 950 may be an example of displaying second AI notification information 951 in which an icon of an application blinks. The processor 120 may display the second AI notification information 951 when the user does not touch the icon of the application even after the first AI notification information 931 is displayed. The second AI notification information 951 may provide an indicator different from that of the first AI notification information 931.

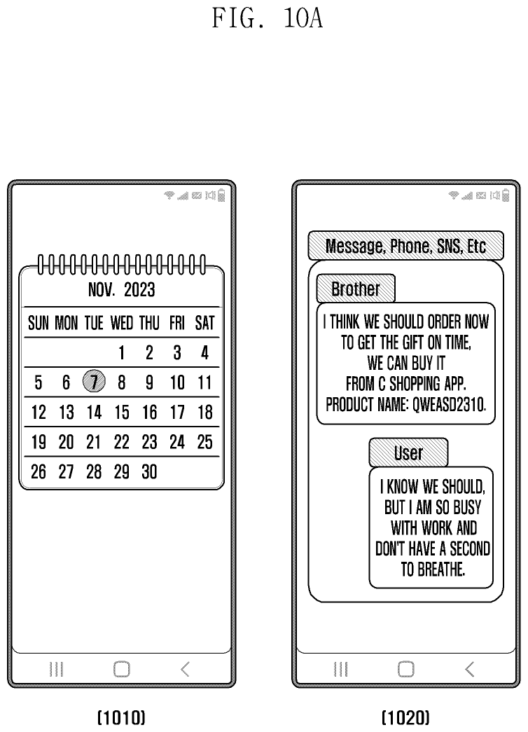

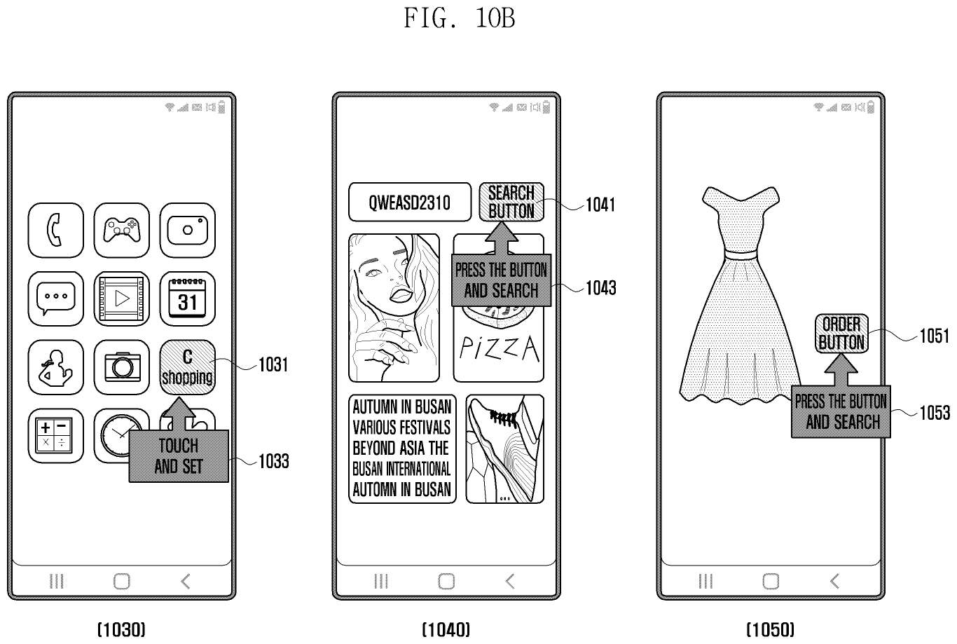

FIGS. 10A and 10B are diagrams illustrating an example in which an electronic device displays AI notification information according to various example embodiments.

Referring to FIG. 10A, a processor (e.g., the processor 120 in FIG. 1) of an electronic device (e.g., the electronic device 101 in FIG. 1) according to an embodiment may generate prompt information by analyzing schedule information 1010 stored in a schedule application and conversation information 1020 stored in a messenger application. A generative AI may generate AI notification information based on the prompt information. The generative AI may be included in the electronic device 101 or an external server. The generative AI may refer to an artificial intelligence neural network that generates a new type of data based on user input information. The generative AI is a model trained to output a statistically optimal output value based on an input value, and may recognize various types of data inputs such as a character, an image, and voice, and generate new data corresponding thereto. The schedule information 1010 may include a schedule of the mother's birthday 3 days after the current time. The conversation information 1020 may be content of conversation with a younger sibling stored in a family group in a contact information application. The processor 120 may extract “mom,” “birthday gift,” “C shopping app,” and “QWEASD2310” as keywords from the schedule information 1010 and the conversation information 1020, and analyze the same.

The processor 120 may identify that the user has not yet bought a birthday gift for the mother, based on a card record obtained from a card application, an account transfer history obtained from a banking application, or an order history obtained from the shopping application. The processor 120 may analyze the collected information, transfer, to the generative AI, the current state of the electronic device 101, in which the user is holding the electronic device 101 and a home screen is displayed on the display (e.g., the display module 160 in FIG. 1), and generate prompt information for requesting generation of an AI notification. The processor 120 may provide a first user interface 1030 when an action predicted via the generative AI is not performed. The first user interface 1030 may display an icon 1031 of a shopping application differently from icons of other applications and include a first reminder text 1033.

When the icon 1031 of the shopping application is selected, the processor 120 may display a second user interface 1040 on the display module 160. The second user interface 1040 may include a product code of “QWEASD2310” displayed in a search field in the shopping application, a search button 1041 blinking, and a second reminder text 1043. When the search button 1041 is selected in the second user interface 1040, the processor 120 may display a third user interface 1050 on the display module 160. The third user interface 1050 may include an order button 1051 blinking in a product page corresponding to the product code “QWEASD2310” and may include a third reminder text 1053.

By following the AI notification information displayed on the first user interface 1030, the second user interface 1040, and the third user interface 1050 in sequence, the user may easily purchase the mother's birthday gift.

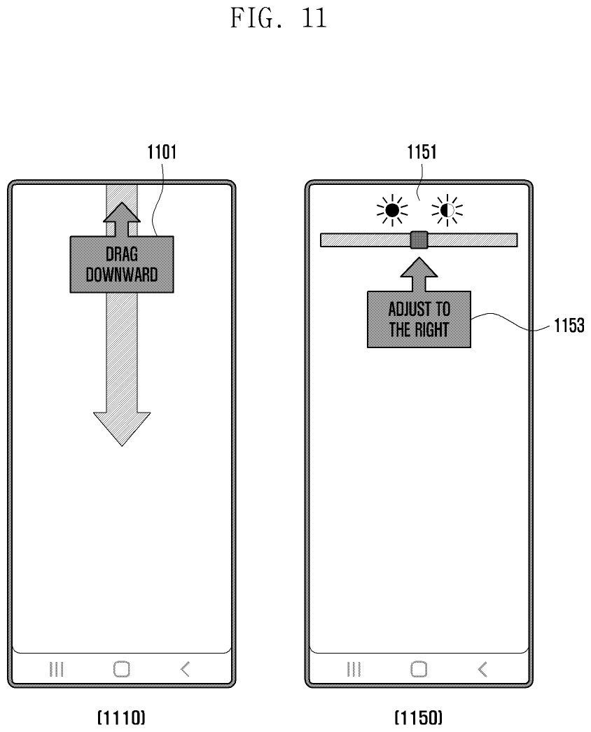

FIG. 11 is a diagram illustrating an example in which an electronic device displays AI notification information according to various example embodiments.

Referring to FIG. 11, a processor (e.g., the processor 120 in FIG. 1) of an electronic device (e.g., the electronic device 101 in FIG. 1) according to an embodiment may display a first user interface 1110 including a first user interaction as first AI notification information 1101, on a display (e.g., the display module 160 in FIG. 1). The processor 120 may provide the first user interface 1110 when an action predicted via a generative AI is not performed (e.g., when brightness of a display is not adjusted although a user needs to adjust the same). The first AI notification information 1101 may be a guide for user interaction, so that the user inputs a drag downward in the central direction of the display module 160 from an upper bezel area of the display module 160. The processor 120 may display a second user interface 1150 including a second user interaction as second AI notification information 1153, on the display module 160. The second AI notification information 1153 may provide a guide for selecting an adjustment bar for adjusting screen brightness 1151.

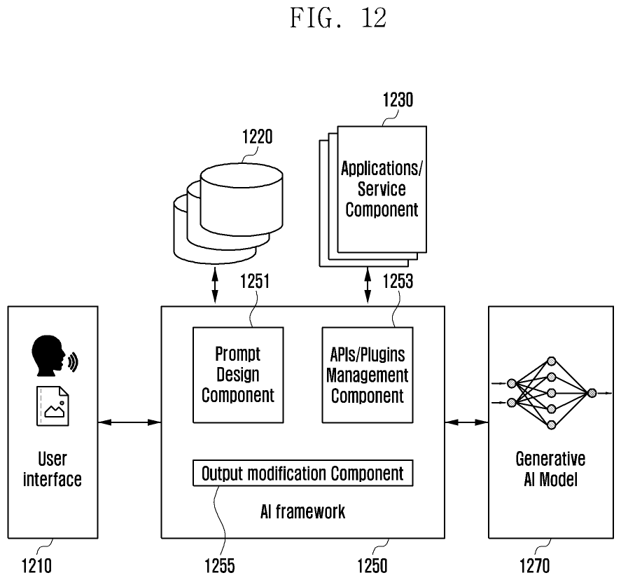

FIG. 12 is a block diagram illustrating an example configuration of a generative artificial intelligence system according to various example embodiments.

Referring to FIG. 12, a generative artificial intelligence system (e.g., an intelligent server or the server 108 in FIG. 1) according to an embodiment may include a user interface 1210, a database 1220, application and service components 1230, an AI framework 1250, and a generative AI model 1270.

The user interface 1210 may receive an input of a user query. The user query may have the form of natural language, images, and videos. In addition, when the user makes a query, context information may be transmitted together. As another example, the user query can be an unnatural input that does not generate natural language such as a design request or a modification. A mixed form of the above-described natural language, image, sound, and context information is also possible. Moreover, the user interface 1210 may output the result of the generative artificial intelligence system to the user. The output may be in the form of natural language or a specific content, and may also be provided in the form of an action requested by the user.

The AI framework 250 may receive an input of the user query, and coordinate and control each component necessary to perform the user's intention. The AI framework 250 may include a prompt design component 1251, an application and plugin (APIs/plugins) management component 1253, and an output modification component 1255.

The user query or action input through the user interface 1210 may be transmitted to the prompt design component 1251. The prompt design component 1251 may be used to generate a prompt suitable for the input into a large language model (LLM) or large multimodal models. The prompt design component 1251 may be an AI component that uses machine learning algorithms or neural networks to develop better prompts as time passes. The prompt design component 1251 may access a knowledge component including user preference data, a prompt library, and prompt examples to generate a prompt and transfer the same to a large language model (LLM) or a large multi-modal model (LMM).

The application and plugin management component 1253 may serve to perform communicating with external information if there is a request for additional information when a user input is transferred as the input of the generative model. The application and plug-in management component 1253 may construct a channel capable of communicating with the outside of the AI interface through an application programming interface (API), thereby allowing access to various data sources. In addition, when an action for performing the user query rather than the intermediate result should be finally performed by an application or a service, the application and plugin management component 1253 may make a request for the corresponding action through an API. The information secured from the outside may be transferred as the input of the generative model together with the user input.

The output modification component 1255 may finely tune the result output from the generative model. For example, the output modification component 1255 may verify whether the content generated through a language model (LLM) or a large-scale multimodal model (LMM) is irrelevant, includes biased content, or includes harmful content. The output correction component 1255 may determine to which extent the output conforms to a desired result of the user, and if an additional process is needed, perform the corresponding process. The output correction component 1255 may configure a hint for avoiding an unintended output and provide the same to the user.

The generative AI model 1270 generally refers to an artificial intelligence neural network that makes new types of data, depending on user input information. Typical models for generating images include a generative adversarial network (GAN) and a variational auto encoder (VAE), and recently, a diffusion-based generative model using a VAE and a Transformer structure is referred to as a generative model. The language model may refer to a model trained to output the most appropriate output value statistically based on the input value, and examples thereof representatively include models such as CHAT-GPT 3 and CHAT-GPT 4. Moreover, the model may recognize various types of data inputs, such as text, images, and sounds, and generate new data in response thereto, and thus is called a large multimodal model (LMM).

A method of operating the electronic device 101 according to an example embodiment of the disclosure may include an operation of collecting at least one of information stored in an application installed in the electronic device, information stored in a memory, an event received via the application, information stored in the memory, or configuration information configured in the electronic device, an operation of determining a usage pattern of a user by analyzing the collected information, an operation of generating prompt information to be provided to a generative artificial intelligence (AI) by analyzing the usage pattern of the user, an operation of generating AI notification information via the generative AI, based on the prompt information; and an operation of providing the AI notification information when an action predicted via the generative AI is not performed.

The operation of generating the prompt information may include an operation of generating the prompt information related to a user action, based on at least one of the current state of the electronic device, content displayed on a display, conversation content of a messenger application, conversation content of an SNS application, a user action collected at a predetermined time, or the user's preference.

The operation of displaying may include an operation of displaying, as the AI notification information, an indicator providing a guide for execution of a predetermined application, execution of a predetermined function of an application, or user interaction.

The method may further include an operation of generating new AI notification information, based on an operation state of the electronic device by the user, when a user input with respect to the AI notification information is not detected.

The method may further include an operation of not providing the AI notification information to the user, based on the current state of the electronic device, content displayed on a display, or the current user action, after generating the AI notification information, and deleting the AI notification information.

The method may further include an operation of updating the usage pattern of the user, based on a user action with respect to the electronic device, when a user input with respect to the displayed AI notification information is not detected, and an operation of generating new prompt information to be provided to the generative AI by analyzing the updated usage pattern of the user.

The operation of determining may include an operation of determining the usage pattern of the user by analyzing the current time, the current operation state of the electronic device, location information of the electronic device, or information obtained from an external server with which a user account of the electronic device is registered or an external device connected to the electronic device.

The operation of determining may include an operation of determining the usage pattern of the user by learning content displayed on the display at a predetermined time and a user action with respect to the electronic device.

The operation of providing may include an operation of providing the AI notification information when at least one of the current time, the current operation state of the electronic device, or location information of the electronic device corresponds to a condition for provision of the AI notification.

The various embodiments of the disclosure are merely examples presented to easily describe the technical contents of the disclosure and to help in understanding of the disclosure, and are not intended to limit the scope of the disclosure. Therefore, the scope of the disclosure is not limited to the above-described example embodiments, and all modifications or modified forms derived from the technical idea of the disclosure, as well as the example embodiments described here, should be understood as falling within the scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a memory storing instructions; and
at least one processor, comprising processing circuitry,
wherein the instructions stored in the memory, when executed by at least one processor, individually or in any combination, cause the electronic device to:
collect at least one of information stored in an application installed in the electronic device, an event received via the application, information stored in the memory, and/or configuration information configured for the electronic device;
analyze the collected information to determine a usage pattern of a user;
analyze the usage pattern of the user to generate prompt information to be provided to a generative artificial intelligence (AI);
generate AI notification information through the generative AI, based on the prompt information; and
provide the AI notification information based on an action predicted through the generative AI not being performed.

2. The electronic device of claim 1, wherein the instructions, when executed by at least one processor, individually or in any combination, cause the electronic device to generate the prompt information related to a user action, based on at least one of a current state of the electronic device, content displayed on the display, conversation contents of a messenger application, conversation contents of an SNS application, a user action collected at a specified time, and/or the user's preference.

3. The electronic device of claim 2, wherein the instructions, when executed by at least one processor, individually or in any combination, cause the electronic device to: display, as the AI notification information, an indicator guiding execution of a specified application, execution of a specified function of an application, and/or user interaction.

4. The electronic device of claim 1, wherein the instructions, when executed by at least one processor, individually or in any combination, cause the electronic device to generate new AI notification information, based on an operation state of the electronic device by the user, based on a user input with respect to the AI notification information not being detected.

5. The electronic device of claim 1, wherein the instructions, when executed by at least one processor, individually or in any combination, cause the electronic device to, after generating the AI notification information, delete the AI notification information without providing the AI notification information to the user, based on a current state of the electronic device and/or a current user action.

6. The electronic device of claim 1, wherein the instructions, when executed by at least one processor, individually or in any combination, cause the electronic device to:
based on a user input with respect to the AI notification information not being detected, update the usage pattern of the user, based on a user action with respect to the electronic device; and
analyze the updated usage pattern of the user to generate new prompt information to be provided to the generative AI.

7. The electronic device of claim 1, wherein the instructions, when executed by at least one processor, individually or in any combination, cause the electronic device to analyze a current time, a current operation state of the electronic device, location information of the electronic device, and/or information obtained from an external server with which a user account of the electronic device is registered and/or an external device connected to the electronic device to determine the usage pattern of the user.

8. The electronic device of claim 1, wherein the instructions, when executed by at least one processor, individually or in any combination, cause the electronic device to learn content displayed on the display at a specified time and a user action with respect to the electronic device to determine the usage pattern of the user.

9. The electronic device of claim 1, wherein the instructions, when executed by at least one processor, individually or in any combination, cause the electronic device to provide the AI notification information based on at least one of a current time, a current operation state of the electronic device, and/or location information of the electronic device corresponding to a condition for providing the AI notification.

10. A method of operating an electronic device, the method comprising:
collecting at least one of information stored in an application installed in the electronic device, an event received via the application, information stored in a memory, and/or configuration information configured for the electronic device;
analyzing the collected information to determine a usage pattern of a user;
analyzing the usage pattern of the user to generate prompt information to be provided to a generative artificial intelligence (AI);
generating AI notification information through the generative AI, based on the prompt information; and
providing the AI notification information based on an action predicted through the generative AI not being performed.

11. The method of claim 10, wherein the generating of the prompt information comprises generating the prompt information related to the user action, based on at least one of a current state of the electronic device, content displayed on a display, conversation contents of a messenger application, conversation contents of an SNS application, a user action collected at a specified time, and/or the user's preference.

12. The method of claim 10, wherein the displaying comprises displaying, as the AI notification information, an indicator guiding execution of a specified application, execution of a specified function of an application, and/or user interaction.

13. The method of claim 10, further comprising generating new AI notification information, based on an operation state of the electronic device by the user, based on a user input with respect to the AI notification information not being detected.

14. The method of claim 10, further comprising, after generating the AI notification information, deleting the AI notification information without providing the AI notification information to the user, based on a current state of the electronic device, content displayed on a display, and/or a current user action.

15. The method of claim 10, further comprising:
based on a user input with respect to the displayed AI notification information not being detected, updating the usage pattern of the user, based on a user action with respect to the electronic device; and
analyzing the updated usage pattern of the user to generate new prompt information to be provided to the generative AI.

16. The method of claim 10, wherein the determining comprises determining the usage pattern of the user by analyzing the current time, the current operation state of the electronic device, location information of the electronic device, or information obtained from an external server with which a user account of the electronic device is registered or an external device connected to the electronic device.

17. The method of claim 10, wherein the determining comprises determining the usage pattern of the user by learning content displayed on the display at a predetermined time and a user action with respect to the electronic device.

18. The method of claim 10, wherein the providing comprises providing the AI notification information when at least one of the current time, the current operation state of the electronic device, or location information of the electronic device corresponds to a condition for provision of the AI notification.

19. In a non-transitory computer-readable recording medium storing instructions that cause an electronic device to perform operations when executed by a processor of the electronic device, the operations comprising:
collecting at least one of information stored in an application installed in the electronic device, an event received via the application, information stored in a memory, and/or configuration information configured for the electronic device;
analyzing the collected information to determine a usage pattern of a user;
analyzing the usage pattern of the user to generate prompt information to be provided to a generative artificial intelligence (AI);
generating AI notification information through the generative AI, based on the prompt information; and
providing the AI notification information based on an action predicted through the generative AI not being performed.
